(19) United States
(12) Patent Application Publication
(10) Pub. No.: US 2012/0004962 A1
(43) Pub. Date: Jan. 5, 2012

(54) BROKERING AN INCENTIVIZED COMMERCIAL TRANSACTION

(76) Inventor: Molly K. Noe, Lake Havasu City, AZ (US)

(21) Appl. No.: 13/170,153

(22) Filed: Jun. 27, 2011

Related U.S. Application Data
(60) Provisional application No. 61/358,768, filed on Jun. 25, 2010.

(51) Int. Cl. G06Q 30/00

(52) U.S. Cl. 705/14.11

(57) ABSTRACT

An apparatus and associated method for a processor based computing system having logic stored in the computing system in the form of computer-readable instructions stored in memory that are executable so that a business subscriber can create a coupon to incentivize a commercial transaction, the coupon identifying the business subscriber and a consumer subscriber that created the coupon, the apparatus and method operably calculating and accounting for a first financial incentive to the redeemer of the coupon, via a consumer incentive derived by predefined rules stored in the apparatus, and for a second financial incentive to the consumer subscriber, via at least one of an advertising distributor incentive and a system administrator incentive derived by predefined rules stored in the apparatus.

### FIELD

The present embodiments relate generally to devices and associated methods for incentivizing commercial transactions and more particularly, but not by way of limitation, to systematic automated solutions providing a business entity with a subscriber repository for publishing commercial incentives and providing an independent-agent consumer subscriber with tools to create, distribute, and account for an advertisement, such as a coupon, ultimately used by a customer of the business entity in redeeming the commercial incentive. The consumer subscriber in such a way brokers the commercial transaction between the business subscriber and its customer in a highly effective and efficient manner.

### BRIEF DESCRIPTION OF THE DRAWINGS

FIG. 1 is a diagrammatic depiction of a world-wide-web architecture used to broker an incentivized commercial transaction in accordance with embodiments of the present invention.

FIG. 2 is functional block depiction of a computer system operated upon by the web server network of FIG. 1.

FIG. 3 is a diagrammatic depiction of financial incentives that are derived in accordance with embodiments of the present invention.

### DETAILED DESCRIPTION OF ILLUSTRATIVE EMBODIMENTS

Generally, embodiments of the present invention contemplate devices and associated methods for automating brokerage of incentivized commercial transactions. Competition can be fierce among businesses vying to attract new customers and retain the loyalty of existing customers. Incentivizing a commercial transaction, such as by special targeted discounts is a proven way of accomplishing both. Coupons used to redeem such discounts can be the old fashioned paper tag type, but those are steadily being replaced in our automated existence by electronic coupons (e-coupons) to potential customers. The claimed embodiments contemplate all types of coupons and all manner of distributing the coupons, and a skilled artisan does not need all those types enumerated in order to understand the scope of the claimed subject matter so no such enumeration is attempted.

An effective way of distributing the coupons, whatever the type, is monumental to obtaining the value they are meant to bring to the business. Whether by conventional postal delivery or by email delivery, one attempted solution is for the business entity offering the targeted discount to distribute the coupons to the potential customers, either in a direct distribution or a mass distribution. The former is problematic because the business entity typically lacks the knowledge and expertise to identify who the direct mail recipients should be. The latter is also problematic because the business entity can only hope that at least some of the coupons will reach potential customers who will redeem them. Although a relatively inexpensive approach, coupon distribution by the business entity is usually proven to be a very inefficient way of stimulating a robust customer base.

At the other end of the cost spectrum the business entity may decide to advertise the directed discounts in print or video media. However, such advertising is an inherently expensive “scorched-earth” solution that aims to inform many more people than those who are actually potential customers. Although the cost can be scaled back by targeting the advertising to a local area, the production costs alone for a quality media advertisement can be prohibitive.

Generally, the present embodiments are directed to improvements in the field that employ free market incentives by way of an independent-agent third party who brokers the commercial transaction between the business entity and the potential customer from knowledge of what incentives a business subscriber is willing to give and knowledge of what purchases a consumer is looking to make.

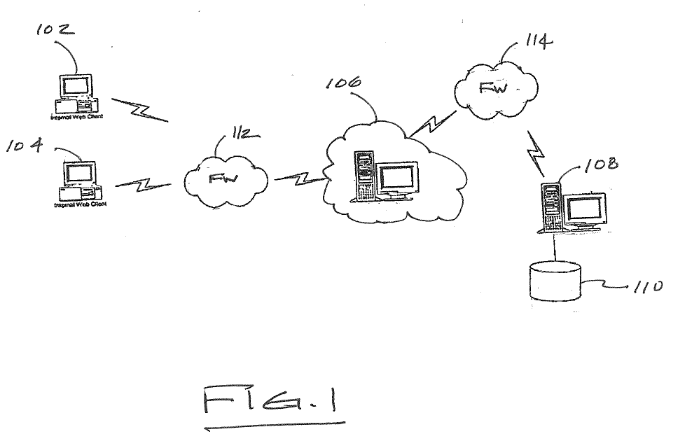

FIG. 1 diagrammatically illustrates a world-wide-web architecture system 100 used by business subscribers and by consumer subscribers to broker an incentivized commercial transaction in accordance with embodiments of the present invention. FIG. 1 depicts a business subscriber (BS) web client 102 (sometimes referred to herein as “BS”). “Business subscriber,” for purposes of this description and meaning of the claims, means a business entity who has subscribed to the automated system for brokering incentivized commercial transactions in accordance with embodiments of this invention. By “subscribed” it is meant that the business entity has rendered some consideration, such as a subscription fee, for the benefit of communicating targeted discounts to the subscriber base that it is willing to honor in order to stimulate sales of its goods and/or services.

FIG. 1 also depicts a consumer subscriber (CS) web client 104 (sometimes referred to herein as “CS”). “Consumer subscriber,” for purposes of this description and meaning of the claims, similarly means an independent agent who likewise has subscribed to the automated system of the present embodiments. As a subscriber the CS is able to view the incentives listed by the BSs that are not necessarily, and preferably are not, otherwise in the public domain. The CS functions as in independent-agent who brokers the incentivized commercial transaction between a BS and a customer seeking to purchase the BS's goods and/or services. FIG. 1 also depicts a web server network 106 and a distributed storage server 108 with corresponding distributed storage database 110. The computer system diagrammatically depicted in FIG. 1 is merely illustrative and not limiting of the scope of the claimed invention. In equivalent alternative embodiments, for example, one or more local area networks can be employed in the distribution of stored data commonly shared and accessed by the BS web client 102 and the CS web client 104.

The BS web client 102 and the CS web client 104 access a designated system website, hosted or otherwise accessed by the web server network 106, via a firewall application 112. The firewall application limits access to information via the website to those who have paid the requisite fee and who otherwise remain in good standing with the system administrator as subscribers to the system, be they BS 102 or CS 104. The web server network 106, in turn, communicates with the distributed storage server 108 via another firewall application 114. For example, BS 102 and CS 104 can use the firewall application 112 to login and connect to the web server network 106 using the hyper-text-transfer-protocol (HTTP) to enable the connection and communication between the subscribers 102, 104 and the web server network 106. Similarly, the web server client 106 can use the firewall application 114 to communicate with the distributed storage server 108 and database 110 via Oracle SQL*Net.

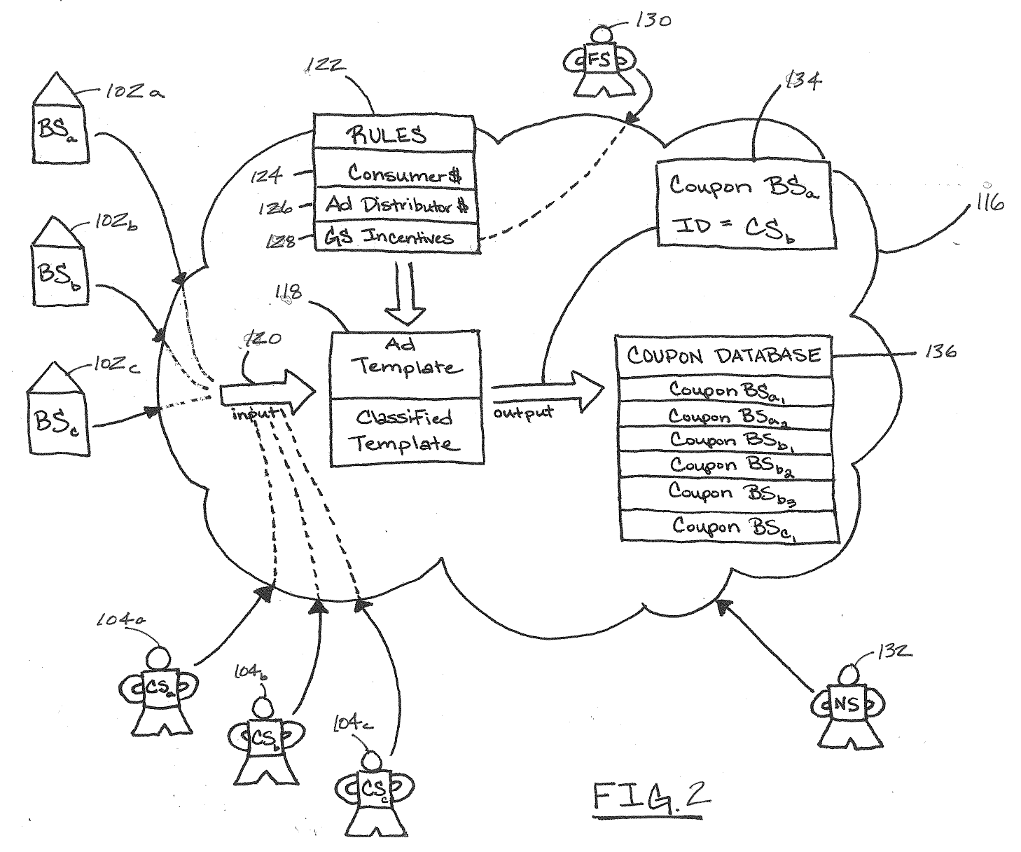

Web server network 106 routes requests between the subscribers 102, 104 and the distributed storage server 108. FIG. 2 is a functional block depiction of salient activities of a computer system 116 managed by the web server network 106 to broker incentivized commercial transactions in accordance with these claimed embodiments. The system 116 is a processor-based computer system that operably executes programming instructions stored in memory to perform the method embodiments described herein. The system 116 includes a template module 118 enabling a subscriber having access rights granted to an input 120 of the template module 118 to create and publish to the subscriber community a commercial business advertisement or a classified advertisement. The template module 118 provides access to a complement of tools that enable the subscriber to create either highly graphics-enhanced advertisements for a more expensive subscription fee or less graphics-enhanced classified advertisements for a comparatively less expensive subscription fee. FIG. 2 depicts three business subscribers BSₐ, BS_{b}, BS_{c} and three consumer subscribers CSₐ, CS_{b}, CS_{c} having operable access to the input 120 for creating and publishing advertisements to the subscriber community, each having paid a respective subscription fee.

A rules module 122 defines predetermined rules for commercial transaction incentives that can be communicated via the advertisements created with the template module 118. The rules include consumer (“C”) incentives 124, advertisement distributor (“AD”) incentives 126, and system administrator (“SA”) incentives 128. Each BS 102 and CS 104 has access to exploit all the incentives 124, 126, 128 by having been granted access to the input 120 via their respective paid subscriptions.

A free subscriber (“FS”) 130 and a non-subscriber (“NS”) 132 have limited access to view a predefined subset of the information that is otherwise available to the BS 102 and the CS 104. The FS 130 and the NS 132 do not, however, have any access rights to the template module 118 via the input 120. The FS 130 is distinguishable from the NS 132 in that the FS 130 has divulged its own identification information to the system 116. Accordingly, although the FS 130 has not financially invested in a subscription as the BS 102 and CS 104 have done, the FS 130 nonetheless enjoys the benefits of the SA incentives 128. For example, without limitation, the SA incentives 128 can include financial remuneration for recruiting a new BS 102 or a new CS 104 to the system 116.

The template module 118 as constrained by the rules 122 and governed by the input 120 produces, for example, a coupon 134 with at least two incentives. The coupon 134 can be electronically distributed to facilitate quick and easy world-wide distribution, or the coupon 134 can be physically manifested in the traditional form of a paper tag and the like. The coupon 134 permits any of the CSs 104 to broker an incentive for a commercial transaction with any of the BSs 102. For example, the coupon 134 depicted in FIG. 2 creates a unique combined financial incentive to the creator of the coupon 134, who in this example advertised and incentivized by BSₐ 102ₐ. The created coupons 134, can advantageously be stored in a memory queue 136, residing either in the web server network 106 itself or in the distributed storage 110 (FIG. 1), for the convenient reusage of a particular coupon without having to recreate it each time.

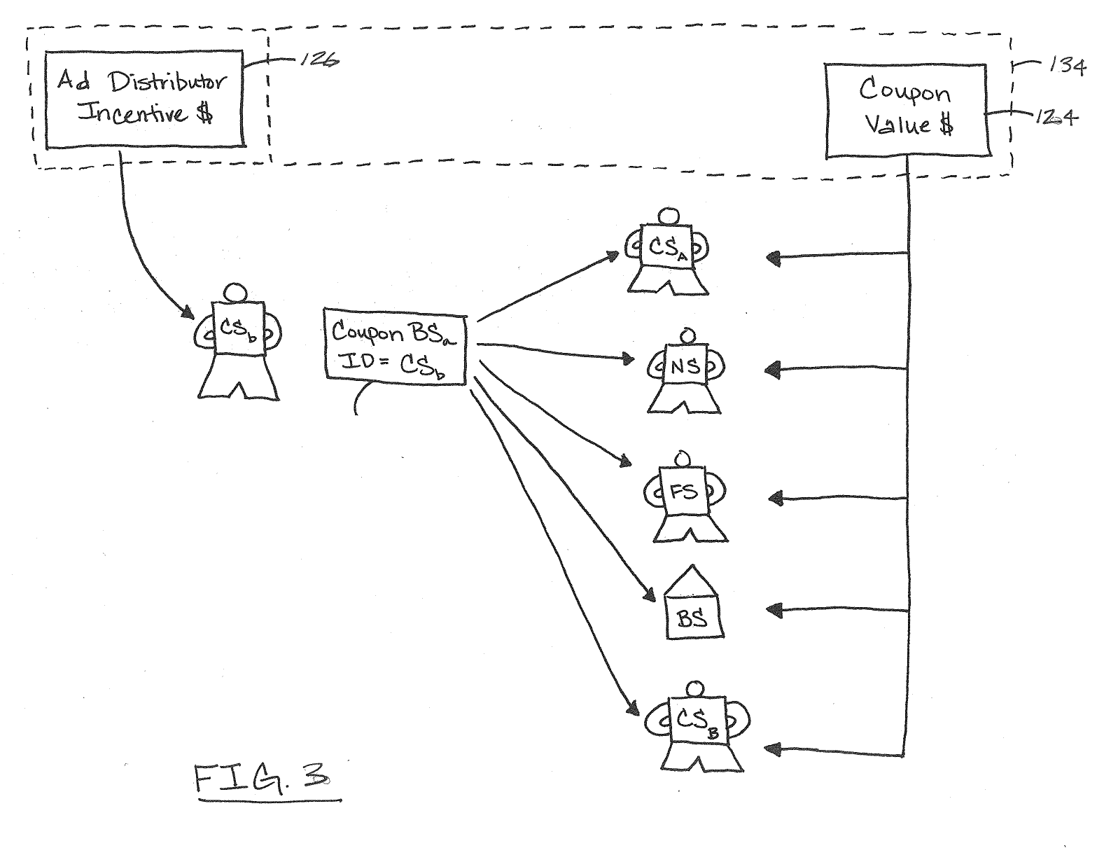

FIG. 3 diagrammatically depicts two different financial incentives that are calculated and delivered by the system 116 stemming from the foregoing illustrative example. CS_{b} 102_{b}, the creator of the coupon 134 in this case for brokering a commercial incentive advertised by BSₐ 102ₐ, can exploit the created coupon in any of a number of different ways. event the C incentive 124 is calculated and delivered to CS_{b} 104_{b} when she redeems the coupon. Alternatively, CS_{b} 104_{b} might send the coupon 134 to a BS 102, an FS 130, an NS 132, or another CS 104, as depicted by the respective arrows in this diagrammatic depiction. Any of those recipients that redeem the coupon provided by CS_{b} 104_{b} will enjoy the C incentive 124 from the system 116. Further, in each of those brokered commercial transactions CS_{b} 104_{b} will also enjoy the benefit of the AD incentive 126 calculated and delivered by the system 116.

In equivalent alternative embodiments the CS 104 who brokers an incentivized commercial transaction receives only an SA incentive 128 instead of any AD incentive 126 from the respective BS 102. In that case the SA incentives 128 are funded by a marketing fee paid by the BS 102 to the system administrator which, in turn remunerates the SA incentive 128 to the CS 104. A BS 102 can pay a fixed fee amount to the system administrator which is incrementally reduced by the payment of SA incentives 128. In some embodiments when the fixed fee amount is entirely spent in SA incentive 128 distributions then the BS 102 subscription is automatically terminated; otherwise the BS 102 can be granted an option to renew its subscription before termination takes effect.

Generally, the present embodiments contemplates an apparatus comprising a processor based computing system; and logic stored in the computing system in the form of computer-readable instructions stored in memory that are executable to create a coupon associated with a commercial transaction, the coupon identifying a business subscriber ultimately performing the commercial activity and a consumer subscriber that created the coupon, the apparatus operably calculating and accounting for a first financial incentive to the recipient of the coupon who redeems it, via a consumer incentive derived by predefined rules stored in the apparatus, and for a second financial incentive to the creator of the coupon, via at least one of an advertising distributor incentive and a system administrator incentive derived by predefined rules stored in the apparatus.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, features of the illustrated embodiments can be interchanged and the particular elements may vary depending on the particular application while maintaining substantially the same functionality without departing from the scope and spirit of the present invention. In addition, although preferred embodiments described herein are illustrated with respect to a system it will be appreciated by those skilled in the art that the teachings of the present invention can be applied to other systems without departing from the scope and spirit of the present invention.

What is claimed:

1. An apparatus comprising:
a processor based computing system; and
logic stored in the computing system in the form of computer-readable instructions stored in memory that are executable to create a coupon associated with a commercial transaction that is incentivized by a business subscriber, the coupon identifying the business subscriber and a consumer subscriber that created the coupon, the apparatus operably calculating and accounting for a first financial incentive to the redeemer of the coupon, via a consumer incentive derived by predefined rules stored in the apparatus, and for a second financial incentive to the consumer subscriber, via at least one of an advertising distributor incentive and a system administrator incentive derived by predefined rules stored in the apparatus.
